(19) United States
(12) Patent Application Publication
(10) Pub. No.: US 2026/0115085 A1
(43) Pub. Date: Apr. 30, 2026

(54) ADJUSTING MECHANISM AND A FOLDABLE WALKING FRAME WITH THE SAME

(71) Applicant: HEBEI HEALTHPLUS MEDICAL DEVICE CO., LTD., Handan City (CN)

(72) Inventors: Chi-Lo SU, Handan City (CN); Haishan LI, Handan City (CN)

(21) Appl. No.: 18/988,473

(22) Filed: Dec. 19, 2024

(30) Foreign Application Priority Data
Oct. 28, 2024 (CN) 202411508571.6

(51) Int. Cl. A61H 3/00

(52) U.S. Cl. CPC A61H 3/00; A61H 2201/0161

(57) ABSTRACT

A foldable walking frame includes a first armrest rod, a second armrest rod spaced apart from the first armrest rod, and an adjusting mechanism. The adjusting mechanism has a first bracket connected with the first armrest rod, a second bracket connected with the second armrest rod, and a locking member releasably locking the second bracket relative to the first bracket to position the second bracket in a required angular position. The foldable walking frame is operably shiftable between an unfolded state and a folded state when the second bracket is rotated relative to the first bracket to adjust the size thereof for facilitating carrying and storing of the foldable walking frame.

### CROSS-REFERENCE TO RELATED APPLICATION

This application claims priority to Chinese Patent Application No. 202411508571.6, filed on Oct. 28, 2024, and incorporated by reference herein in its entirety.

### FIELD

The disclosure relates to a foldable walking frame, and more particularly to a foldable walking frame with an adjusting mechanism to adjust an angular position thereof and be locked in a required angular position.

### BACKGROUND

A conventional walking frame is used by people with mobility disability for support so as to maintain their balance and stability while walking. The conventional walking frame has a simple and fixed structure and cannot be folded into a smaller size so it is inconvenient to be carried and stored. Another conventional walking frame has a telescopic crosspiece for folding and unfolding the walking frame. However, a complicated locking device is required to lock and unlock the telescopic crosspiece, which renders the structure of the walking frame complicated and the operation thereof inconvenient.

### SUMMARY

Therefore, an object of the disclosure is to provide an adjusting mechanism and a foldable walking frame with the same that can alleviate at least one of the drawbacks of the prior art.

According to an aspect of the disclosure, the adjusting mechanism includes a first bracket, a second bracket rotatably connected with the first bracket about a longitudinal axis in a vertical direction and selectively positioned relative to the first bracket in a required angular position, and a locking member releasably locking the second bracket relative to the first bracket to position the second bracket in the required angular position.

According to another aspect of the disclosure, the foldable walking frame includes a first armrest rod, a second armrest rod spaced apart from the first armrest rod in a left-right direction, and an adjusting mechanism as described above. The first bracket and the second bracket are respectively connected with the first armrest rod and the second armrest rod such that the foldable walking frame is shiftable between an unfolded state and a folded state when the second bracket is rotated relative to the first bracket about the longitudinal axis.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a perspective view illustrating an embodiment of a foldable walking frame according to the disclosure in an unfolded state.

FIG. 2 is an exploded perspective view of the embodiment.

FIG. 3 is a fragmentary sectional view taken along line III-III of FIG. 2, illustrating a state when a locking member is in a locking position.

FIG. 4 is an exploded perspective view of an adjusting mechanism of the embodiment.

FIG. 5 is an exploded perspective view of the adjusting mechanism taken from another angle.

FIG. 6 is a fragmentary rear view of the embodiment.

FIG. 7 is a fragmentary sectional view similar to FIG. 3, illustrating a state when the locking member is in an unlocking position.

FIG. 8 is a front view of the adjusting mechanism, illustrating a state when a first toothed ring of a first bracket is separated from a second toothed ring of a second bracket.

FIG. 9 is a top view of the embodiment, illustrating a state when the foldable walking frame is folding from the unfolded state.

FIG. 10 is a top view of the embodiment, illustrating the foldable walking frame is in the folded state.

FIG. 11 is an exploded perspective view illustrating an adjusting mechanism of another embodiment according to the disclosure.

FIG. 12 is an exploded perspective view of the adjusting mechanism taken from another angle.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly. In the following description, a front-rear direction (X), a left-right direction (Y) and a vertical direction (Z) are transverse to one another.

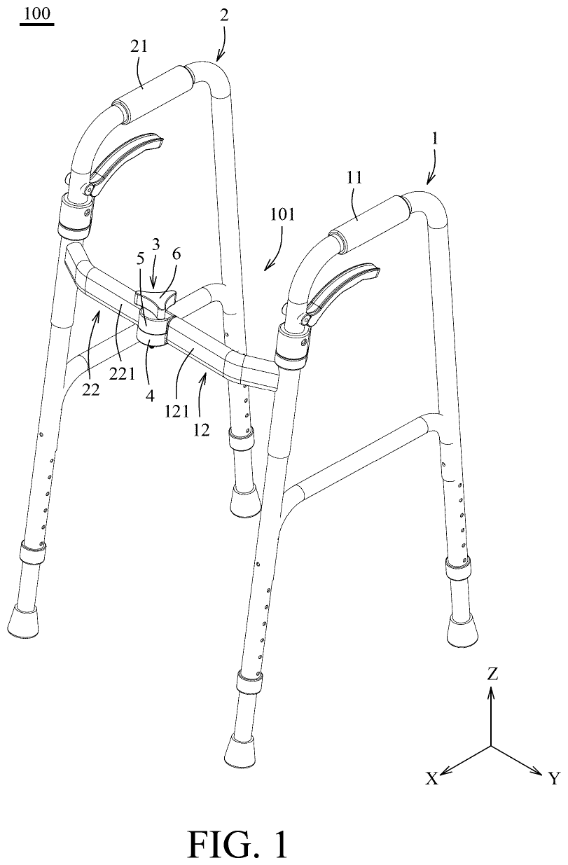

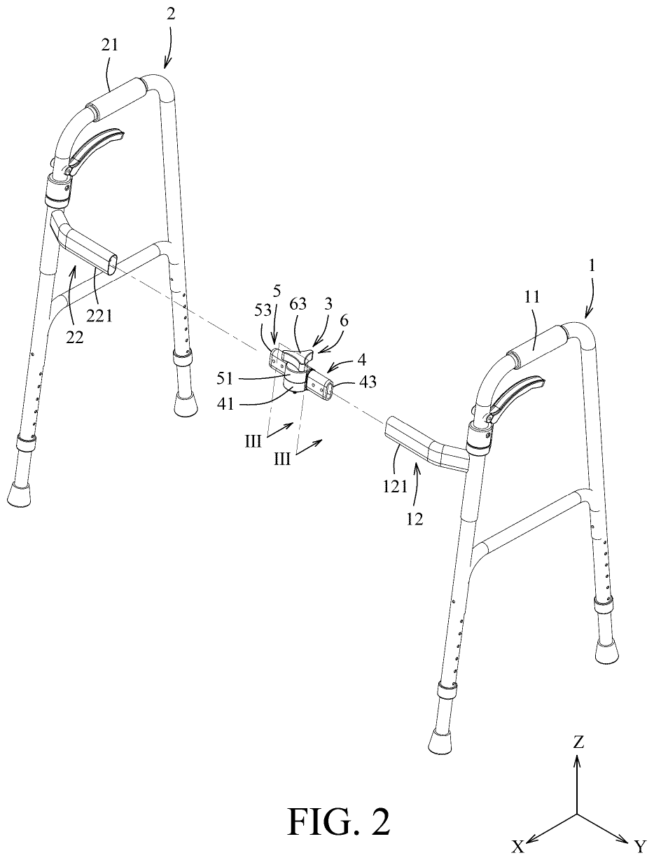

Referring to FIGS. 1 and 2, an embodiment of a foldable walking frame 100 according to the disclosure includes a first armrest rod 1, a second armrest rod 2 and an adjusting mechanism 3. The first armrest rod 1 and the second armrest rod 2 are spaced apart from each other in the left-right direction (Y). The first armrest rod 1 includes an H-shaped first armrest rod portion 11 and a first connecting rod portion 12 which is rotatably connected with a front end of the first armrest rod portion 11. The first connecting rod portion 12 has a first crosspiece 121 extending in the left-right direction (Y). The second armrest rod 2 includes an H-shaped second armrest rod portion 21 and a second connecting rod portion 22 which is rotatably connected with a front end of the second armrest rod portion 21. The second connecting rod portion 22 has a second crosspiece 221 extending in the left-right direction (Y). The adjusting mechanism 3 is interposed between the first crosspiece 121 and the second crosspiece 221 to adjust the angle between the first armrest rod 1 and the second armrest rod 2. The first armrest rod 1 and the second armrest rod 2 cooperatively define an accommodation space 101 therebetween for accommodating a user.

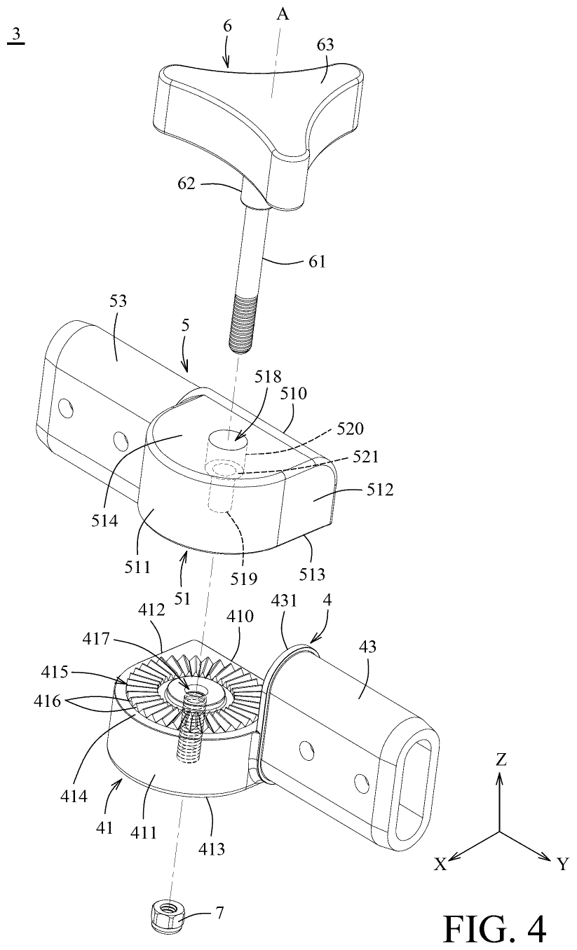

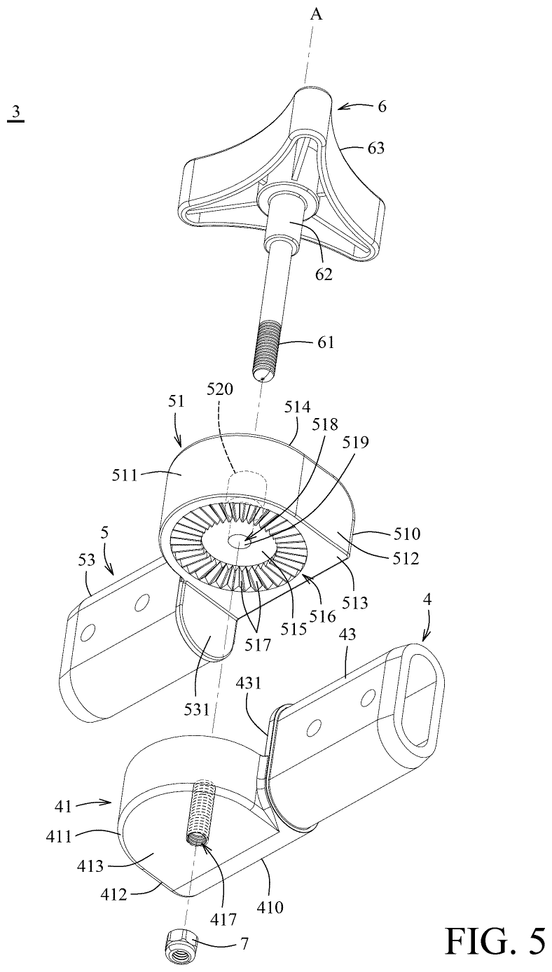

With reference to FIGS. 2 to 5, the adjusting mechanism 3 includes a first bracket 4, a second bracket 5 and a locking member 6. The first bracket 4 and the second bracket 5 are respectively connected with the first crosspiece 121 of the first armrest rod 1 and the second crosspiece 221 of the second armrest rod 2. The second bracket 5 is rotatably connected with the first bracket 4 about a longitudinal axis (A) in the vertical direction (Z) and is selectively positioned relative to the first bracket 4 in a required angular position. The locking member 6 is to releasably lock the second bracket 5 relative to the first bracket 4 to position the second bracket 5 in the required angular position.

The first bracket 4 includes a first pivot disc 41 and a first connecting bar 43. The first pivot disc 41 includes a first elongated disc portion 410 and a first semi-circular disc portion 411. The first elongated disc portion 410 is elongated in the left-right direction (Y), and is connected with the first connecting bar 43. The first elongated disc portion 410 has a first end upright wall 412 opposite to the first connecting bar 43 and facing rightwardly. The first semi-circular disc portion 411 extends forwardly from the first elongated disc portion 410. The first pivot disc 41 has a bottom surface 413, an upper surface 414 opposite to the bottom surface 413 in the vertical direction (Z), and a first engaging portion 415. Specifically, the first elongated disc portion 410 and the first semi-circular disc portion 411 cooperatively define the bottom surface 413 and the upper surface 414. The first engaging portion 415 is in the form of a first toothed ring 415 which is formed on and projects from the upper surface 414 and surrounds the longitudinal axis (A). The first toothed ring 415 has a plurality of first teeth 416 which extend radially and surround the longitudinal axis (A). Additionally, the first elongated disc portion 410 and the first semi-circular disc portion 411 are cooperatively formed with a screw hole 417 which extends therethrough along the longitudinal axis (A).

The first connecting bar 43 extends from a distal end (i.e., a left end) of the first elongated disc portion 410 opposite to the first end upright wall 412 in the left-right direction (Y). The first connecting bar 43 is insertable into and secured to the first crosspiece 121 by means of a screw fastener. The first connecting bar 43 has a portion projecting upwardly of the upper surface 414 and having a first abutted upright wall 431 which is connected with and transverse to the upper surface 414.

The second bracket 5 includes a second pivot disc 51 and a second connecting bar 53. The second pivot disc 51 has a shape similar to that of the first pivot disc 41, and is rotatably and movably mounted on an upper end of the first pivot disc 41. The second pivot disc 51 includes a second elongated disc portion 510 and a second semi-circular disc portion 511. The second elongated disc portion 510 is elongated in the left-right direction (Y), and is connected with the second connecting bar 53. The second elongated disc portion 510 has a second end upright wall 512 opposite to the second connecting bar 53 and facing leftwardly to be in abutting engagement with the first abutted upright wall 431 of the first bracket 4. The second semi-circular disc portion 511 extends forwardly from the second elongated disc portion 510. The second pivot disc 51 has a lower surface 513, a top surface 514 opposite to the lower surface 513 in the vertical direction (Z), an annular recessed surface 515 and a second engaging portion 516. Specifically, the second elongated disc portion 510 and the second semi-circular disc portion 511 cooperatively define the lower surface 513, the top surface 514 and the annular recessed surface 515. The lower surface 513 faces and is in abutting engagement with the upper surface 414 of the first bracket 4. The annular recessed surface 515 is recessed upwardly from the lower surface 513, and is spaced apart from the lower surface 513 along the longitudinal axis (A). The second engaging portion 516 is in the form of a second toothed ring 516 which is formed on and projects from the annular recessed surface 515, and which surrounds the longitudinal axis (A). The second toothed ring 516 is removably meshable with the first toothed ring 415. Specifically, the second toothed ring 516 has a plurality of second teeth 517 which extend radially and surround the longitudinal axis (A) to respectively mesh with the first teeth 416.

Additionally, the second elongated disc portion 510 and the second semi-circular disc portion 511 are cooperatively formed with a through hole 518 which extends therethrough along the longitudinal axis (A) to be in communication with an upper portion of the screw hole 417. The through hole 518 includes a smaller-diameter section 519 in communication with the upper portion of the screw hole 417, and a larger-diameter section 520 in communication with an upper portion of the smaller-diameter section 519 and having an inner diameter larger than that of the smaller-diameter section 519 to form a shoulder therebetween. The shoulder serves as a forced surface 521 facing upwardly.

The second connecting bar 53 extends from a distal end (i.e., a right end) of the second elongated disc portion 510 opposite to the second end upright wall 512 in the left-right direction (Y). The second connecting bar 53 is insertable into and secured to the second crosspiece 221 by means of a screw fastener. The second connecting bar 53 has a portion projecting downwardly of the lower surface 513 and having a second abutted upright wall 531 which is connected with and transverse to the lower surface 513. The second abutted upright wall 531 is to be in abutting engagement with the first end upright wall 412 of the first bracket 4.

The locking member 6 has a threaded bolt 61, an enlarged head 62 and a rotary knob 63. The threaded bolt 61 extends through the through hole 518 of the second bracket 5 and is threadedly engaged with the screw hole 417 of the first bracket 4, and a lower portion of the threaded bolt 61 extends downwardly of the bottom surface 413 of the first bracket 4. The enlarged head 62 is connected with an upper end of the threaded bolt 61, and has an outer diameter larger than that of the threaded bolt 61 and the inner diameter of the smaller-diameter section 519 to abut against the forced surface 521 when the threaded bolt 61 extends through the smaller-diameter section 519. Through the screwing movement of the threaded bolt 61, the enlarged head 62 is moved to abut against the forced surface 521 to bring the second pivot disc 51 in tight engagement with the first pivot disc 41. An upper portion of the enlarged head 62 projects upwardly of the top surface 514 of the second bracket 5. The rotary knob 63 is connected with the upper portion of the enlarged head 62 and is disposed above and spaced apart from the top surface 514 of the second bracket 5 to be operated by a user to rotate and move the locking member 6 between a locking position and an unlocking position.

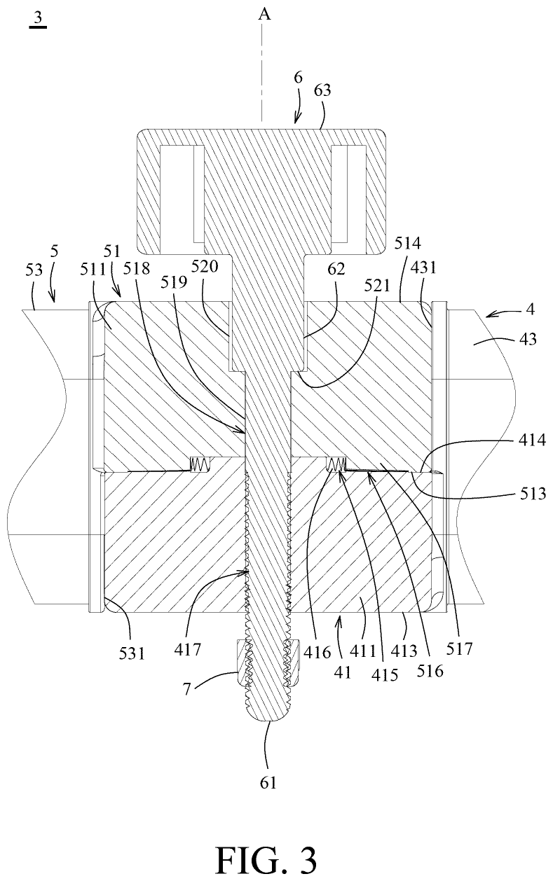

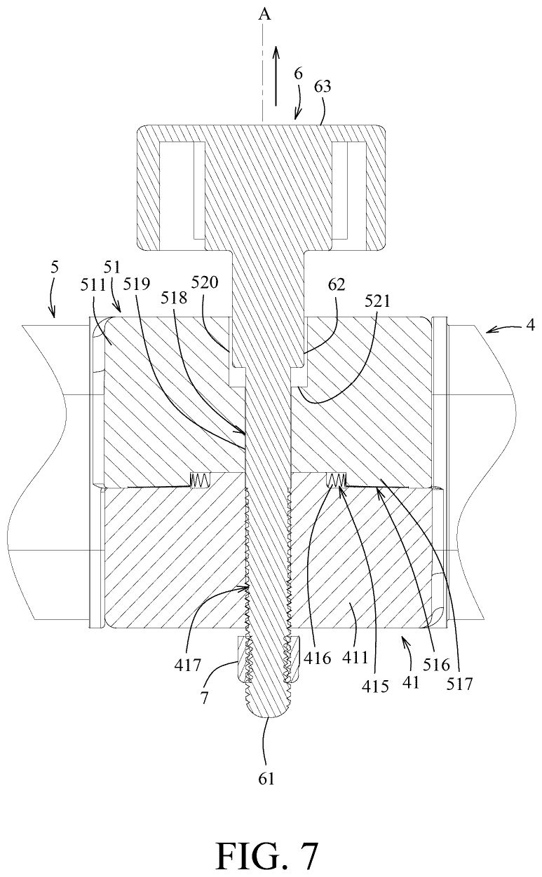

Specifically, the locking member 6 is operable along the longitudinal axis (A) between the locking position (as shown in FIG. 3) and the unlocking position (as shown in FIG. 7). When the locking member 6 is in the locking position, the enlarged head 62 abuts against the forced surface 521 of the second bracket 5 to lock the second bracket 5 to the first bracket 4. When the locking member 6 is in the unlocking position, the enlarged head 62 is moved upwardly and is spaced apart from the forced surface 521 by a distance such that the second bracket 5 is permitted to be moved upwardly along the longitudinal axis (A) to bring the second teeth 517 of the second toothed ring 516 to disengage from the first teeth 416 of the first toothed ring 415 and the second bracket 5 is permitted to be rotated relative to the first bracket 4 about the longitudinal axis (A) to adjust the angular position thereof.

The adjusting mechanism 3 further includes a threaded nut 7 which is threadedly engaged with the projecting lower portion of the threaded bolt 61 and which is spaced apart from the bottom surface 413 of the first bracket 4. The threaded nut 7 is moved with the threaded bolt 61 during the screwing movement, and abuts against the bottom surface 413 of the first bracket 4 so as to prevent removal of the threaded bolt 61 from the screw hole 417 and the through hole 518 during the upward movement of the locking member 6.

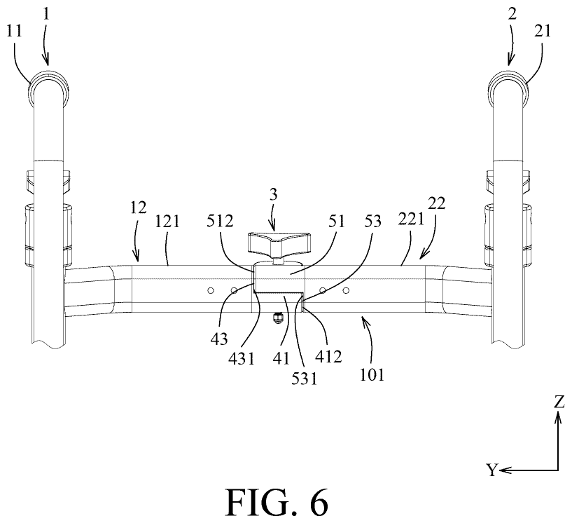

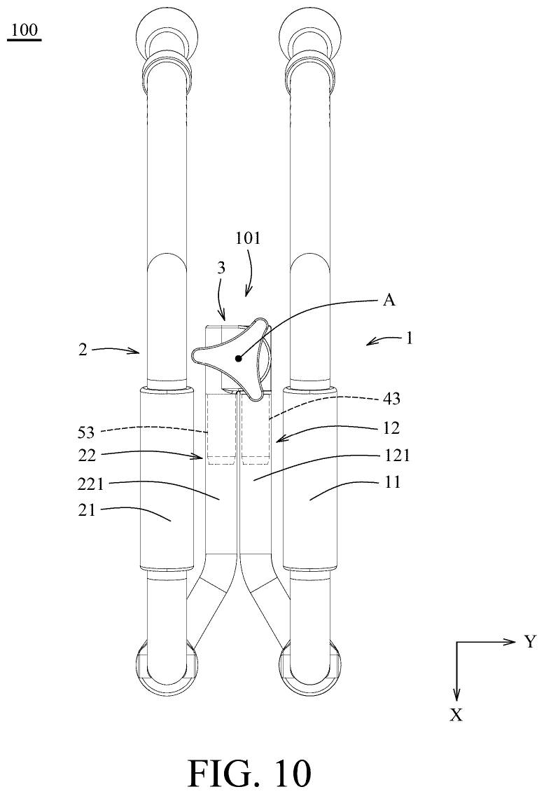

With reference to FIG. 1 and FIGS. 3 to 6, when the locking member 6 is in the unlocking position, the second bracket 5 is rotatable relative to the first bracket 4 between an extended angular position (as shown in FIG. 6) and a folded angular position (as shown in FIG. 10). When the first abutted upright wall 431 and the second abutted upright wall 531 are in abutting engagement with the second end upright wall 512 and the first end upright wall 412, respectively, and the second teeth 517 of the second toothed ring 516 mesh with the first teeth 416 of the first toothed ring 415, the second bracket 5 is prevented from rotation relative to the first bracket 4 so as to be retained in the extended angular position. At this stage, the first connecting bar 43 is aligned with the second connecting bar 53 in the left-right direction (Y), and the first armrest rod 11 and the second armrest rod 21 are parallel to each other so as to place the foldable walking frame 100 in an unfolded state. By the locking member 6 being operated to the locking position, the second bracket 5 is locked to the first bracket 4 and is retained in the extended angular position.

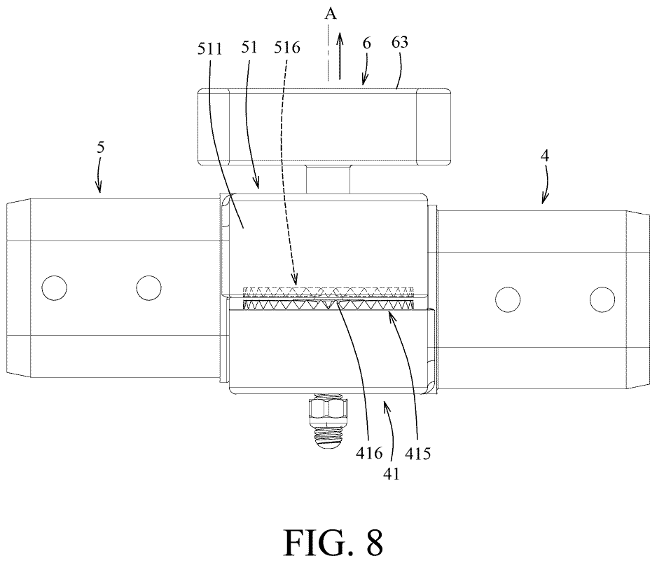

With reference to FIGS. 7 to 10, when it is desired to fold the foldable walking frame 100 for carrying or storing the same, the rotary knob 63 is operably rotated counterclockwise to move the locking member 6 upwardly along the longitudinal axis (A) to the unlocking position, as shown in FIG. 7, where the enlarged head 62 is separated from the forced surface 521 and is spaced apart from the forced surface 521 by an appropriate distance. Subsequently, the second armrest rod 2 is moved upwardly to permit the second teeth 517 to be disengaged from the first teeth 416. Then, the second armrest rod 2 is rotated in a rotational direction (R) about the longitudinal axis (A) to rotate the second bracket 5 relative to the first bracket 4 to a required angular position. During the rotation of the second armrest rod 2 in the rotational direction (R), the second armrest rod portion 21 is gradually moved away from the first armrest rod portion 11 of the first armrest rod 1.

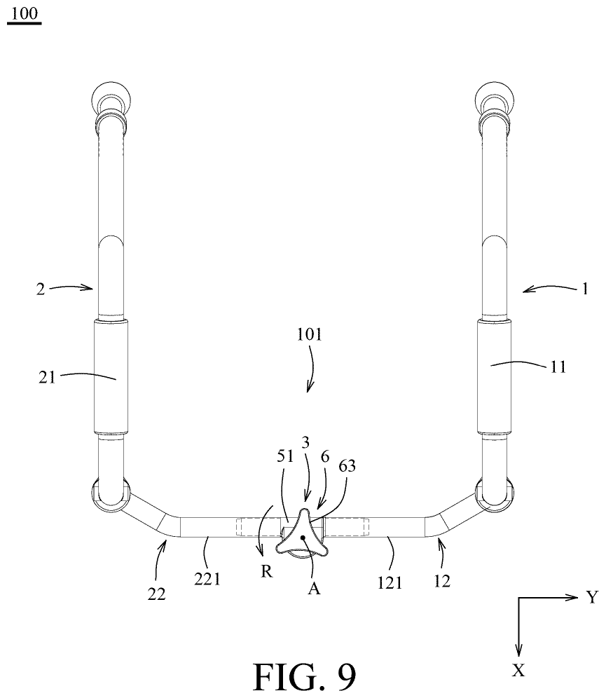

With reference to FIGS. 3 and 9, subsequently, the second armrest rod 2 is moved downwardly to permit the second teeth 517 of the second toothed ring 516 to mesh with the first teeth 416 of the first toothed ring 415, and permit the lower surface 513 to be in abutting engagement with the upper surface 414. Thus, the second bracket 5 and the second armrest rod 2 are positioned in the required angular position. Moreover, with the second toothed ring 516 formed on and projecting from the annular recessed surface 515, the second teeth 516 mesh with the first teeth 416 while the lower surface 513 is in abutting engagement with the upper surface 414. Thus, the first pivot disc 41 steadily and firmly supports the second pivot disc 51 to improve the stability of the second bracket 5.

Finally, the rotary knob 63 is rotated clockwise to move the locking member 6 downwardly along the longitudinal axis (A) to the locking position, as shown in FIG. 3, such that the enlarged head 62 is moved to abut against the forced surface 521 to bring the second bracket 5 in tight engagement with the first bracket 4. Thus, the second bracket 5 and the second armrest rod 2 are firmly positioned in the required angular position.

Additionally, the first armrest rod portion 11 of the first armrest rod 1 is rotatable relative to the first connecting rod portion 12 toward the second armrest rod portion 21, and the second armrest rod portion 21 of the second armrest rod 2 is rotatable relative to the second connecting rod portion 22 toward the first armrest rod portion 11, which decreases the accommodation space 101 to reduce the size of the foldable walking frame 100.

With reference to FIG. 3 and FIG. 10, when it is desired to fold the foldable walking frame 100 to a smallest size, the second armrest rod 2 and the second bracket 5 as well is rotated in the rotational direction (R) (as shown in FIG. 9) about the longitudinal axis (A) to the folded angular position. At this stage, the first abutted upright wall 431 and the second abutted upright wall 531 are separated from the second end upright wall 512 of the second pivot disc 51 and the first end upright wall 412 of the first pivot disc 41, respectively, and the first connecting bar 43 is parallel to the second connecting bar 53 in the front-rear direction (X). Then, through the engagement of the second teeth 517 with the first teeth 416, the second bracket 5 is positioned in the folded angular position. Subsequently, the locking member 6 is screwed tight to bring the second bracket 5 in tight engagement with the first bracket 4 to be retained in the folded angular position. Finally, the first armrest rod portion 11 of the first armrest rod 1 is rotated relative to the first connecting rod portion 12 to be closer to the first crosspiece 121, and the second armrest rod portion 21 of the second armrest rod 2 is rotated relative to the second connecting rod portion 22 toward the second crosspiece 221 so as to shift the foldable walking frame 100 to the folded state to minimize the size of the foldable walking frame 100.

Through the adjusting mechanism 3 for adjusting the angle between the first armrest rod 1 and the second armrest rod 2, the size of the foldable walking frame 100 may be adjusted such that the foldable walking frame 100 may be conveniently carried in a reduced form, and may be conveniently stored in a predetermined storage space (not shown). Moreover, with the first engaging portion in the form of the first toothed ring 415 and the second engaging portion in the form of the second toothed ring 516, the second bracket 5 can be positioned in any required angular position relative to the first bracket 4 so as to fold the foldable walking frame 100 to any required size.

With the threaded bolt 61 of the locking member 6 extending along the longitudinal axis (A) through the through hole 518 and threadedly engaged with the screw hole 417, the locking member 6 can lock the second bracket 5 to the first bracket 4, and can serve as a pivot axle for pivotally connecting the second bracket 5 with the first bracket 4, which renders the structure of the adjusting mechanism 3 simple and less-costly. Moreover, with the rotary knob 63, the user can operate the locking member 6 conveniently. Furthermore, with the forced surface 521 formed between the smaller-diameter section 519 and the larger-diameter section 520 of the through hole 518, the enlarged head 62 is received in the larger-diameter section 520 so as to reduce the required length of the locking member 6. Additionally, with the first semi-circular disc portion 411 of the first pivot disc 41 and the second semi-circular disc portion 511 of the second pivot disc 51, during the rotation of the second pivot disc 51 relative to the first pivot disc 41, interference of the first semi-circular disc portion 411 with the second semi-circular disc portion 511 is avoided.

Alternatively, in another embodiment, the top surface 514 may serve as the forced surface for the enlarged head 62 to be in abutting engagement therewith.

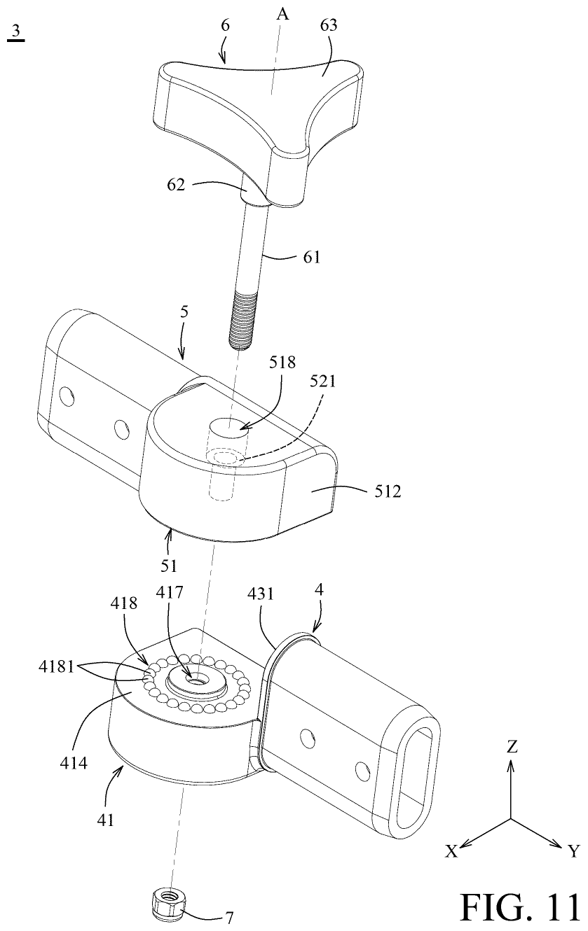

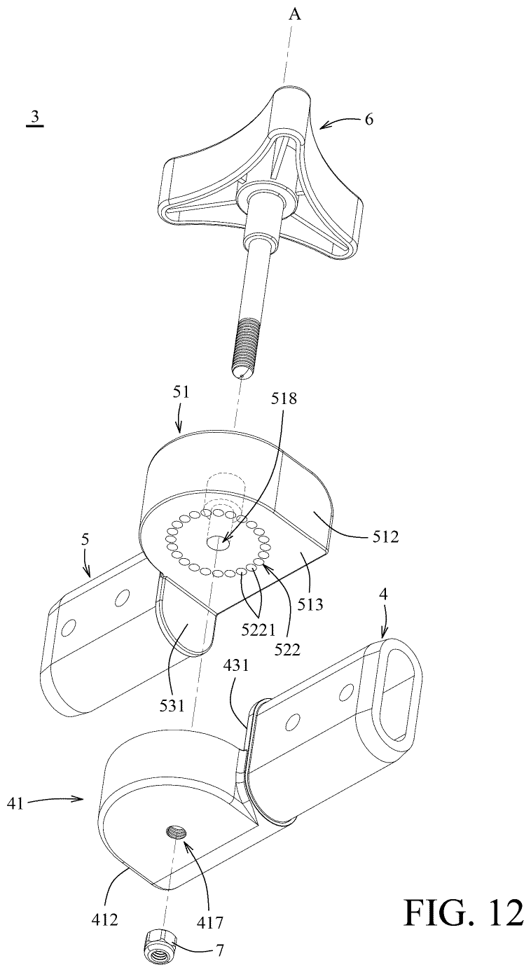

With reference to FIGS. 11 and 12, in another embodiment, the first engaging portion 418 of the first bracket 4 has a plurality of protrusions 4181 which are formed on and project from the upper surface 414 of the first pivot disc 41 and which surround the longitudinal axis (A). The second engaging portion 522 of the second bracket 5 has a plurality of grooves 5221 which are formed in and recessed from the lower surface 513 of the second pivot disc 51 and which surround the longitudinal axis (A) so as to be respectively engaged with the protrusions 4181 to position the second bracket 5 in the required angular position relative to the first bracket 4. Alternatively, the first engaging portion of the first bracket may have a plurality of grooves and the second engaging portion of the second bracket may have a plurality of protrusions.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An adjusting mechanism for a foldable walking frame, comprising:
a first bracket;
a second bracket rotatably connected with said first bracket about a longitudinal axis in a vertical direction and selectively positioned relative to said first bracket in a required angular position; and
a locking member releasably locking said second bracket relative to said first bracket to position said second bracket in the required angular position.

2. The adjusting mechanism of claim 1, wherein said first bracket has a first engaging portion which surrounds the longitudinal axis, said second bracket having a second engaging portion which surrounds the longitudinal axis and removably engages with said first engaging portion, said locking member being operable along the longitudinal axis to an unlocking position, where said second bracket is permitted to be moved upwardly along the longitudinal axis to bring said second engaging portion to disengage from said first engaging portion and to be rotated relative to said first bracket about the longitudinal axis.

3. The adjusting mechanism of claim 2, wherein said first bracket further has an upper surface, said first engaging portion being in form of a first toothed ring which is formed on and projects from said upper surface, said second bracket further having a lower surface which faces and in abutting engagement with said upper surface, and an annular recessed surface which is recessed upwardly from said lower surface, said second engaging portion being in form of a second toothed ring which is formed on and projects from said annular recessed surface.

4. The adjusting mechanism of claim 2, wherein first engaging portion is in form of a first toothed ring having a plurality of first teeth which extend radially and surround the longitudinal axis, said second engaging portion being in form of a second toothed ring having a plurality of second teeth which extend radially and surround the longitudinal axis to respectively mesh with said first teeth.

5. The adjusting mechanism of claim 2, wherein one of said first engaging portion and said second engaging portion has a plurality of protrusions, and the other one of said first engaging portion and said second engaging portion has a plurality of grooves.

6. The adjusting mechanism of claim 5, wherein said first bracket further has an upper surface, said protrusions being formed on and projecting from said upper surface, said second bracket further having a lower surface which faces and in abutting engagement with said upper surface, said grooves being formed in and recessed from said lower surface.

7. The adjusting mechanism of claim 1, wherein said first bracket is formed with a screw hole which extends therethrough along the longitudinal axis, said second bracket being formed with a through hole which extends therethrough along the longitudinal axis and in communication with an upper portion of said screw hole, said second bracket having a forced surface facing upwardly, said locking member having a threaded bolt which extends through said through hole and is threadedly engaged with said screw hole, and an enlarged head which is connected with an upper end of said threaded bolt, said locking member being operable to bring said enlarged head to be in abutting engagement with said forced surface so as to bring said second bracket in tight engagement with said first bracket.

8. The adjusting mechanism of claim 7, wherein said locking member further has a rotary knob connected with an upper end of said enlarged head and disposed above and spaced apart from said second bracket.

9. The adjusting mechanism of claim 7, wherein said through hole includes a smaller-diameter section in communication with said upper portion of said screw hole, and a larger-diameter section in communication with an upper portion of said smaller-diameter section and having an inner diameter larger than that of said smaller-diameter section to form a shoulder therebetween, said shoulder serving as said forced surface, said enlarged head having an outer diameter larger than said inner diameter of said smaller-diameter section to abut against said forced surface when said threaded bolt extends through said smaller-diameter section.

10. The adjusting mechanism of claim 7, wherein a portion of said threaded bolt extends downwardly of a bottom end of said first bracket, said adjusting mechanism further comprising a threaded nut which is threadedly engaged with said portion of said threaded bolt and spaced apart from said bottom end of said first bracket.

11. The adjusting mechanism of claim 1, wherein said first bracket includes a first pivot disc, said first pivot disc being formed with a screw hole which extends along the longitudinal axis therethrough, said second bracket including a second pivot disc which is rotatably and movably mounted on an upper end of said first pivot disc, said second pivot disc being formed with a through hole which extends therethrough along the longitudinal axis and in communication with an upper portion of said screw hole, said locking member having a threaded bolt which extends through said through hole and is threadedly engaged with said screw hole, and an enlarged head which is connected with an upper end of said threaded bolt, said locking member being operable to bring said enlarged head to be in abutting engagement with said forced surface so as to bring said second bracket in tight engagement with said first bracket.

12. The adjusting mechanism of claim 11, wherein said first pivot disc includes a first elongated disc portion and a first semi-circular disc portion extending from said first elongated disc portion in a front-rear direction, said first elongated disc portion having a first end upright wall, said first bracket further including a first connecting bar which extends from a distal end of said first elongated disc portion opposite to said first end upright wall in a left-right direction, said first connecting bar having a first abutted upright wall, said second pivot disc including a second elongated disc portion and a second semi-circular disc portion extending from said second elongated disc portion in the front-rear direction, said second elongated disc portion having a second end upright wall to be in abutting engagement with said first abutted upright wall, said second bracket further including a second connecting bar which extends from a distal end of said second elongated disc portion opposite to said second end upright wall in the left-right direction, said second connecting bar having a second abutted upright wall to be in abutting engagement with said first end upright wall.

13. The adjusting mechanism of claim 1, wherein said first bracket includes a first pivot disc having a first end upright wall, and a first connecting bar which extends from a distal end of said first pivot disc opposite to said first end upright wall in a left-right direction, said first connecting bar having a first abutted upright wall, said second bracket including a second pivot disc which is rotatably and movably mounted on an upper end of said first pivot disc and has a second end upright wall, and a second connecting bar which extends from a distal end of said second pivot disc opposite to said second end upright wall in the left-right direction, said second connecting bar having a second abutted upright wall, wherein said second bracket is rotatable relative to said first bracket between an extended angular position, where said first abutted upright wall and said second abutted upright wall are in abutting engagement with said second end upright wall and said first end upright wall, respectively, and said first connecting bar is aligned with said second connecting bar in the left-right direction, and a folded angular position, where said first abutted upright wall and said second abutted upright wall are separated from said second end upright wall and said first end upright wall, respectively, and said first connecting bar is parallel to said second connecting bar in a front-rear direction.

14. A foldable walking frame, comprising:
a first armrest rod;
a second armrest rod spaced apart from said first armrest rod in a left-right direction; and
an adjusting mechanism as claimed in claim 1, wherein
said first bracket and said second bracket are respectively connected with said first armrest rod and said second armrest rod such that said foldable walking frame is shiftable between an unfolded state and a folded state when said second bracket is rotated relative to said first bracket about the longitudinal axis.

15. The foldable walking frame of claim 14, wherein said first bracket includes a first pivot disc having a first end upright wall, and a first connecting bar which extends from a distal end of said first pivot disc opposite to said first end upright wall in the left-right direction and which is connected with said first armrest rod, said first connecting bar having a first abutted upright wall, said second bracket including a second pivot disc which is rotatably and movably mounted on an upper end of said first pivot disc and has a second end upright wall, and a second connecting bar which extends from a distal end of said second pivot disc opposite to said second end upright wall in the left-right direction and which is connected with said second armrest rod, said second connecting bar having a second abutted upright wall, wherein said second bracket is rotatable relative to said first bracket between an extended angular position, where said first abutted upright wall and said second abutted upright wall are in abutting engagement with said second end upright wall and said first end upright wall, respectively, and said first connecting bar is aligned with said second connecting bar in the left-right direction to place said foldable walking frame in an unfolded state, and a folded angular position, where said first abutted upright wall and said second abutted upright wall are separated from said second end upright wall and said first end upright wall, respectively, and said first connecting bar is parallel to said second connecting bar in a front-rear direction to place said foldable walking frame in a folded state.
